(19) United States
(12) Patent Application Publication
(10) Pub. No.: US 2007/0207292 A1
(43) Pub. Date: Sep. 6, 2007

(54) Soft feel interior trim component and method of making the same

(75) Inventors: Glenn A. Cowelchuk, Chesterfield Tw., MI (US); David M. Emerling, West Bloomfield, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(73) Assignee: Lear Corporation

(21) Appl. No.: 11/368,796

(22) Filed: Mar. 6, 2006

(51) Int. Cl. B32B 1/00

(52) U.S. Cl. 428/174; 428/172

(57) ABSTRACT

An interior component for a motor vehicle comprises a substrate having a surface and flexible elements on the surface, and a cover covering at least a portion of the substrate and the flexible elements.

### BACKGROUND OF INVENTION

The present invention generally relates to interior trim components, particularly, for the passenger compartment of a motor vehicle, and a method for producing interior trim components. More particularly, the present invention relates to interior trim components, such as motor vehicle instrument panels, door panels, bolsters, armrests, console lids, or other soft trim components, wherein the interior trim components give a preferred touch (i.e., soft touch feeling) to a portion where a passenger may touch and support localized portion of his or her weight.

It is known to provide motor vehicle interior trim components that are aesthetically and/or tactilely pleasing to the vehicle passengers. Such trim components commonly have cushioned soft-touch aesthetic features. In particular, interior vehicle door panels often have localized cushioned areas in the armrest. Such localized softness may be provided by a flexible foam or elastomeric pad of varying thickness typically mounted to a rigid structural substrate and surrounded by a relatively harder durometer cover sheet.

It is also known to form motor vehicle armrests by placing a nibbed back surface of a molded vinyl skin against a rigid structural substrate and clamping the vinyl skin to the underside of the substrate with a closure plate. However, known methods of manufacturing such armrests typically require a series of multiple and separate molding and assembly steps, which can add significant cost to each part produced. It would therefore be desirable to provide an improved motor vehicle armrests and method for manufacturing the same.

### SUMMARY OF INVENTION

The present invention is directed towards an interior component for a motor vehicle comprising a substrate having a surface and flexible elements on the surface, and a cover covering at least a portion of the substrate and the flexible elements. The present invention is also directed towards a method for making an interior trim component.

### BRIEF DESCRIPTION OF DRAWINGS

FIG. 1 is a cross-sectional view in side elevation of an interior trim component of motor vehicle.

FIGS. 2A-2E is enlarged cross-sectional views of portions of various exemplary embodiments of a rear elevational view of interior trim component.

FIG. 3 is a cross-sectional view in side elevation of a substrate of the interior trim component being formed.

FIG. 4 is a cross-sectional view in side elevation of a cover of the interior trim component being formed over the substrate.

### DETAILED DESCRIPTION

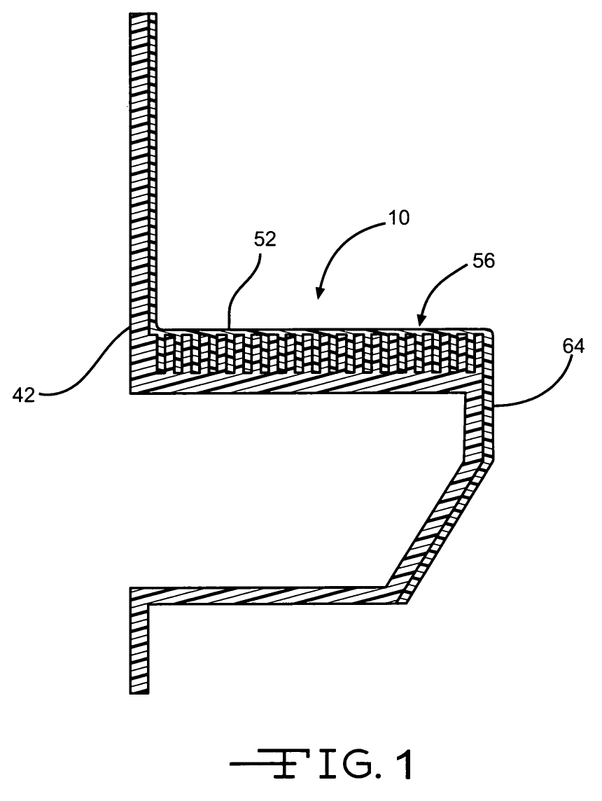

Referring now to the drawings, there is illustrated in FIG. 1 a vehicle armrest assembly, generally shown at 10. In the exemplary embodiment illustrated, the armrest assembly 10 is adapted to be mounted to a vehicle trim panel (not shown). The trim panel of the preferred embodiment is an automotive door trim panel (not shown) that mounts to a vehicle door assembly (also not shown). It will be appreciated however, that the subject invention is not intended to be limited to the armrest 10 shown but may be any desired motor vehicle interior trim component. Additionally, the exemplary armrest assembly 10 may be mounted to any type of trim panel associated with the motor vehicle, such as a center console assembly or the like.

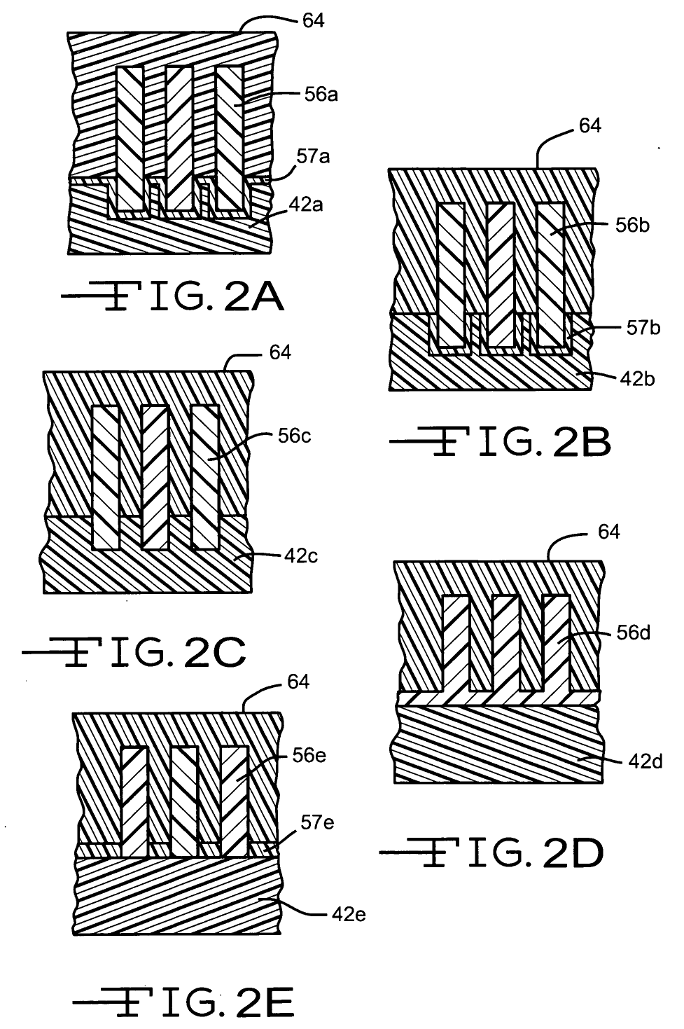

Continuing with reference to FIG. 1, the armrest assembly 10 is illustrated as being comprised of a substrate 42, preferably formed of rigid plastic, most preferably a thermoplastic, such as a thermoplastic olefin (TPO), or may be formed of a glass reinforced urethane (GRU), a styrene/maleic anhydride copolymer (SMA), a polycarbonate (PC), an acrylonitrile butadiene styrene (ABS), a PC-ABS blend, a polypropylene, or a glass filled polypropylene. The substrate 42 may have any desired shape and contour, and includes flexible elements, such as the exemplary ribs or pins, generally indicated at 56, on or extending outwardly from the substrate 42. The ribs or pins 56 form a flexible or weakened movable structure or surface that gives a preferred touch (i.e., soft touch feeling) to a portion where a passenger may touch and support localized portion of his or her weight. The substrate 42 is covered with a cover or skin 52, which is preferably formed from softer thermoplastic, such as thermo plastic elastomer (TPE), thermoplastic olefin (TPO), or thermo plastic vulcanite (TPV). The skin 52 substantially conforms to the shape of the substrate 42 and may be textured so as to create an outer surface 64 of the armrest assembly 10 that is aesthetically and tactilely pleasing. The skin 52 may be bonded to the substrate 42 during a molding process to form the armrest assembly 10. The bonding may be a chemical bonding, or a mechanical bonding. The ribs or pins 56 may be horizontally and/or laterally spaced apart, and may be manufactured having any desired pattern. It should be appreciated that ribs or pins 56a-56e can be supported by a substrate 42a, or embedded or otherwise molded into a substrate 42a-42e, as shown in FIGS. 2A-2E. Ribs or pins 56c-56d may be formed of a material that is more pliable than the substrate 42c-42d and supported on the substrate 42d or molded into the substrate 42c. Alternatively, ribs or pins 56a-56b or may be embedded in the substrate 42a-42b with pliable holders, such as the pliable grommets 57a, 57b shown, or supported relative to the substrate 42e by a single pliable holder 57e. A variety of rib or pin sizes, shapes, and locations can be provided so as to provide a desired feel to the outer surface 64 of the armrest assembly 10.

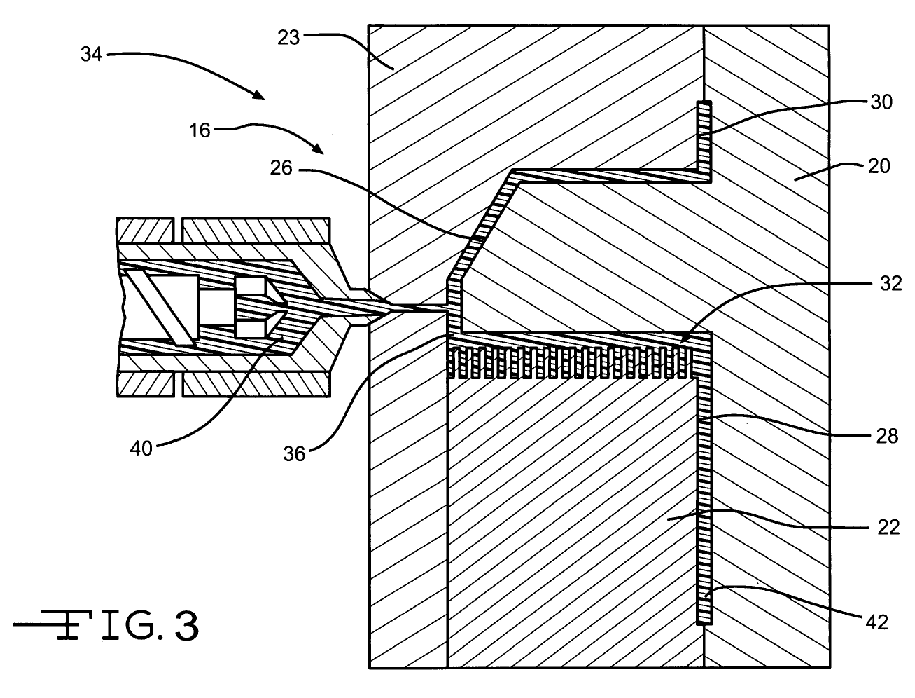

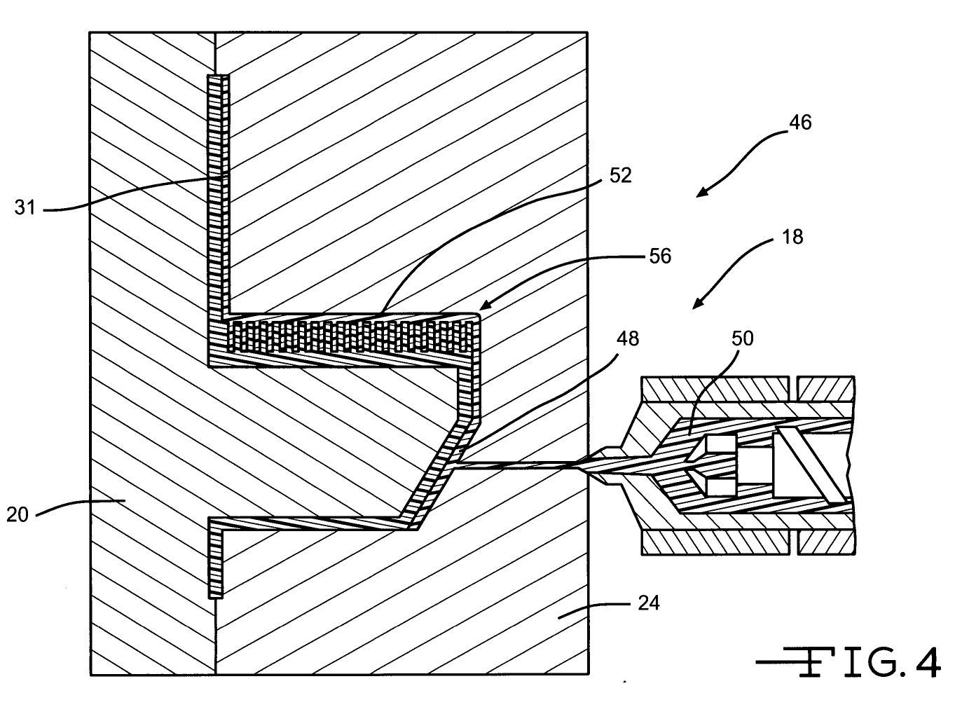

Referring now to FIGS. 3 and 4, there is illustrated a first mold assembly 16, and a second mold assembly 18, respectively, which are adapted to be used in accordance with a method of this invention. Preferably, the first mold assembly 16 includes a first mold section 20, a second mold section 22, and a third mold section 23, as shown in FIG. 3. The second mold assembly 18 includes the first mold section 20 and a fourth mold section 24, as shown in FIG. 4. The first mold section 20 includes a first mold surface 26, the second mold section 22 includes a second mold surface 28, the third mold section 23 includes a third mold surface 30, and the fourth mold section 24 includes a fourth mold surface 31. Preferably, a plurality of voids or holes, generally indicated at 32, extend inward of the third mold surface 28 of the second mold section 22.

Although illustrated schematically in FIGS.3 and 4, it will be appreciated that the mold surfaces 26, 28, and 31 may be of any desired shape and contour. For example, the fourth mold surface 31 can be textured so as to create an aesthetically and tactilely pleasing outer surface 64 of the armrest assembly 10. The mold sections 22, 23, and 24 are preferably mounted to platens (not shown) of presses (not shown), such as vertical and horizontal molding presses, with sufficient tonnage to accomplish the method herein described.

It will be appreciated, that in accordance with each embodiment of the invention, a first step of the method of the invention includes providing a suitable mold assembly, and a plurality of voids or holes.

A second step of the method of this invention is illustrated generally at 34 in FIG. 3. In the second step 34, the first mold assembly 16 is moved to a first closed position, as viewed in FIG. 3. In the first closed position, the first mold section 20, the second mold section 22, and the second mold section 23 define a first cavity 36. A first material 40 is introduced into the first cavity 36. Any desired material can be introduced into the first cavity 36. Preferably the first material 40 is rigid plastic, most preferably a thermoplastic, such as a thermoplastic olefin (TPO), or may be formed of a glass reinforced urethane (GRU), a styrene/maleic anhydride copolymer (SMA), a polycarbonate (PC), an acrylonitrile butadiene styrene (ABS), a PC-ABS blend, a polypropylene, or a glass filled polypropylene. The first material 40 then conforms to the shape of the first cavity 36 and the voids or holes 32, thereby forming a first trim component portion or substrate 42. The second mold section 22 and the third mold section 23 are then moved away from one another.

A third step of the method of this invention is illustrated generally at 46 in FIG. 4. In the third step 46, the first mold section 20 and the fourth mold section 24 are moved into contact with one another and into a second closed position, thereby forming the second mold assembly 18. In the second closed position, the first mold section 20 and the fourth mold section 24 define a second cavity 48. A second material 50 is then introduced into the second cavity 48. Any desired material can be introduced into the second cavity. Preferably, the second material 50 is formed from softer thermoplastic, such as thermo plastic elastomer (TPE), or thermoplastic olefin (TPO), or thermo plastic vulcanite (TPV). The second material 50 may substantially conform to the shape of the second cavity 48 and the pins 56, thereby forming a second trim component portion or skin 52. It will be appreciated that the first and second materials 40 and 50, respectively, may be of the same material. Preferably, however, the first and second materials 40 and 50 are of different materials. More preferably, the first material 40 is relatively harder than the second material 50.

Preferably, the skin 52 becomes chemically bonded to the substrate 42 during the molding process to form the armrest assembly 10. However, such chemical bonding is not required. For example, features, such as recesses and protrusions, provided on the third mold surface 30 of the third mold section 23 may form corresponding ribs or pins 56 extending outwardly from the surface 44 of the substrate 42. Such recesses and protrusion may provide a mechanical bond with the skin 52 after the molten second material hardens to form the skin 52. Alternately, holes or recesses can be formed in the substrate (i.e., about the pins 56), such that the second material at least partially fills the recesses. The second material 50 thereby becomes bonded to the substrate 42 when the second material 50 hardens within the recesses.

The fourth mold section 24 is then moved away from the first mold section 20 and the armrest assembly 10 is removed from the second mold assembly 18. It will be appreciated that the method of the invention can be performed with satisfactory results in a shuttle-mold wherein the second, third and fourth mold sections 22, 23 and 24 move relative to a stationary first mold section 20. The method of the invention can also be performed with satisfactory results in a shuttle-mold wherein the first mold section 20 moves relative to stationary second, third and fourth mold sections 22, 23 and 24, or wherein all mold sections 20, 22, 23 and 24 move relative to one another.

Preferably, the armrest assembly 10 is manufactured using a two-shot molding process. The two-shot molding process may be accomplished by rotating the first mold section 20, such as in a rotational molding process. In such a rotational molding process, the substrate 42 is first injection molded in the first mold assembly 16 as described herein with reference to FIG. 3. The first mold section 20, containing the substrate 42 is then rotated to a second position and joined with the fourth mold section 24 to form the second cavity 48, as shown in FIG. 4. The skin 52 is then injection molded in the second cavity 48. Alternately, two separate molds could be used sequentially to form the substrate 42 and the skin 52.

The method of forming an armrest described herein, and the armrest formed thereby, is advantageous over prior art designs because the two-shot molding process eliminates the manual assembly required by the prior art methods. The method of the invention further improves quality, and eliminates the multiple components, such as structural members or substrates, foam inserts, outer covers or skins, closure plates, and adhesives or fasteners, of known armrest assemblies.

As shown in the drawings, the voids or holes 32 define a plurality of ribs or pins 56. The ribs or pins 56 are on, extend from, or are otherwise supported by the substrate 42, and into communication with the skin 52. The ribs or pins 56 can be arranged in any desired pattern in the armrest assembly 10. Preferably, the ribs or pins 56 are horizontally and/or laterally spaced apart, however the armrest assembly 10 may be manufactured having any desired pattern of ribs or pins 56.

It will also be appreciated that preformed ribs or pins 56a-56e can be on, embedded or otherwise molded into, or supported by the substrate 42a-42e, as described above. As stated above, the ribs or pins 56c-56d may be formed of a material that is more pliable than the substrate 42c-42d and molded into or supported by the substrate 42c-42d, or the ribs or pins 56a, 56b, 56e may be embedded in or otherwise supported by the substrate 42a, 42b, 42e with pliable holders, such as the pliable grommets or holders 57a, 57b, 57c shown.

A variety of rib or pin sizes, shapes, and locations can be provided so as to provide a desired feel to the outer surface 64 of the armrest assembly 10. For example, by varying the sizes, shapes, and locations of the ribs or pins 56, a manufacturer can control the relative softness of the armrest (e.g. how soft the armrest assembly 10 feels to a motor vehicle passenger). The pins can be substantially cylindrical, substantially cylindrical with a tapered distal end portion, or substantially cylindrical with a distal end portion having any other desired shape.

It will be appreciated that the interior trim component 10 can be attached to the vehicle door assembly by any desired method. For example, threaded fasteners can be inserted through an aperture in the interior trim component 10 and into the vehicle door assembly 14. Alternately, an underside or backside of the substrate 42 can include outwardly extending bosses (not shown) which define thermoplastic stakes. Such thermoplastic stakes can be extended through an aperture in the vehicle door assembly. It will be appreciated that the portion of the thermoplastic stake which extends through the vehicle door assembly may be melted and reformed, so as to mechanically bond the interior trim component 10 to the vehicle door assembly. The thermoplastic stake can be melted by any desired means, such as a heated aluminum platen (not shown).

The principle and mode of operation of this invention have been explained and illustrated in its preferred embodiment. However, it must be understood that this invention may be practiced otherwise than as specifically explained and illustrated without departing from its spirit or scope.

What is claimed is:

1. An interior component for a motor vehicle comprising:
a substrate having a surface and flexible elements on the surface; and
a cover covering at least a portion of the substrate and the flexible elements.

2. The component of claim 1 wherein the substrate is injection molded.

3. The component of claim 1 wherein the cover is injection molded.

4. The component of claim 1 wherein the substrate is injection molded and the cover is injection molded onto at least a portion of the substrate and the flexible elements.

5. The component of claim 1 wherein at least a portion of the cover is chemically bonded to at least a portion of the substrate and the flexible elements.

6. The component of claim 1 wherein at least two of the flexible elements are spaced apart to provide a space therebetween and at least a portion of the cover fills at least a portion of the space to bond to at least a portion of the cover to at least a portion of substrate.

7. The component of claim 6 wherein at least a portion of the cover completely fills the space.

8. The component of claim 1 wherein the substrate and the cover are each formed from a thermoplastic.

9. The component of claim 1 wherein the substrate is formed from at least one of either a thermoplastic olefin (TPO), a glass reinforced urethane (GRU), a styrene/maleic anhydride copolymer (SMA), a polycarbonate (PC), an acrylonitrile butadiene styrene (ABS), a PC-ABS blend, a polypropylene, or a glass filled polypropylene.

10. The component of claim 1 wherein the cover is formed from at least one of thermo plastic elastomer (TPE), thermoplastic olefin (TPO), or thermo plastic vulcanite (TPV).

11. The component of claim 1 wherein the cover is colored.

12. The component of claim 1 wherein the cover has a textured surface.

13. The component of claim 1 wherein the flexible elements are pillars extending from the surface of the substrate.

14. The component of claim 1 wherein the substrate and the pillars are formed separately.

15. The component of claim 1 wherein the substrate and the pillars are formed from different materials.

16. A method for producing molding an interior trim component comprising the steps of:
a) providing a mold assembly and a plurality of voids or holes;
b) moving the mold assembly to a first closed position to define a first cavity and introducing a first material into the first cavity and the voids or holes, the first material conforming to the shape of the first cavity and the voids or holes to form a substrate with ribs or pins on the substrate;
c) moving the mold assembly to a second closed position to define a second cavity and introducing a second material into the second cavity, the second material conforming to the shape of the second cavity to form a cover over the ribs or pins and at least a portion of the substrate.

17. The method of claim 16 wherein the substrate and the cover are each formed from a thermoplastic.

18. The method of claim 16 wherein the substrate is formed from at least one of either a thermoplastic olefin (TPO), a glass reinforced urethane (GRU), a styrene/maleic anhydride copolymer (SMA), a polycarbonate (PC), an acrylonitrile butadiene styrene (ABS), a PC-ABS blend, a polypropylene, or a glass filled polypropylene.

19. The method of claim 17 wherein the cover is formed from at least one of thermo plastic elastomer (TPE), thermoplastic olefin (TPO), or thermo plastic vulcanite (TPV).

20. The method of claim 17 wherein the interior trim component is molded using a two-shot rotational molding process, wherein the mold assembly includes a first mold section that is in a first position when molding the substrate and is then rotated to a second position when molding the cover.
